(19) United States
(12) Patent Application Publication
(10) Pub. No.: US 2020/0093237 A1
(43) Pub. Date: Mar. 26, 2020

(54) CELLPHONE AND CREDIT CARD CASE

(71) Applicant: Rachel Coicou, Dublin, CA (US)

(72) Inventor: Rachel Coicou, Dublin, CA (US)

(21) Appl. No.: 16/136,372

(22) Filed: Sep. 20, 2018

(51) Int. Cl. A45C 11/18; A45C 13/00; A45C 13/10; G06K 9/00

(52) U.S. Cl. CPC A45C 11/182; A45C 13/005; A45C 2011/002; G06K 9/00375; A45C 13/10

(57) ABSTRACT

A cellphone and credit card case assembly includes a first panel that has a cellphone that is positionable thereon. A second panel is hingedly coupled to the first panel and each of the first and second panels is positionable in a closed position such that the first and second panels forms a case. The second panel has a plurality of pockets thereon for insertably receiving a respective one of a plurality of card. The cellphone and each of the cards is contained within the case when the first and second panels are closed. A hinge is coupled between each of the first and second panels, a closure flap is coupled to the first panel and an engagement is coupled to the closure flap. A lock is movably coupled to the second panel and releasably engages the engagement.

### CROSS-REFERENCE TO RELATED APPLICATIONS

[symbol]

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

[symbol]

### (2) Description of Related Art including information disclosed under 37 CFR 1.97 and 1.98.

The disclosure and prior art relates to carrying case devices and more particularly pertains to a new carrying case device for carrying a plurality of cards along with a cellphone.

### BRIEF SUMMARY OF THE INVENTION

An embodiment of the disclosure meets the needs presented above by generally comprising a first panel that has a cellphone that is positionable thereon. A second panel is hingedly coupled to the first panel and each of the first and second panels is positionable in a closed position such that the first and second panels forms a case. The second panel has a plurality of pockets thereon for insertably receiving a respective one of a plurality of card. The cellphone and each of the cards is contained within the case when the first and second panels are closed. A hinge is coupled between each of the first and second panels, a closure flap is coupled to the first panel and an engagement is coupled to the closure flap. A lock is movably coupled to the second panel and releasably engages the engagement.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a cellphone and credit card case assembly according to an embodiment of the disclosure showing a first panel and a second panel in an open position.

FIG. 2 is a top perspective view of an embodiment of the disclosure showing a first panel and a second panel in a closed position.

FIG. 3 is a top phantom view of an embodiment of the disclosure.

FIG. 4 is a front phantom view of an embodiment of the disclosure.

FIG. 5 is an exploded perspective view of an embodiment of the disclosure.

FIG. 6 is a perspective view of an alternative embodiment of the disclosure.

### DETAILED DESCRIPTION OF THE INVENTION

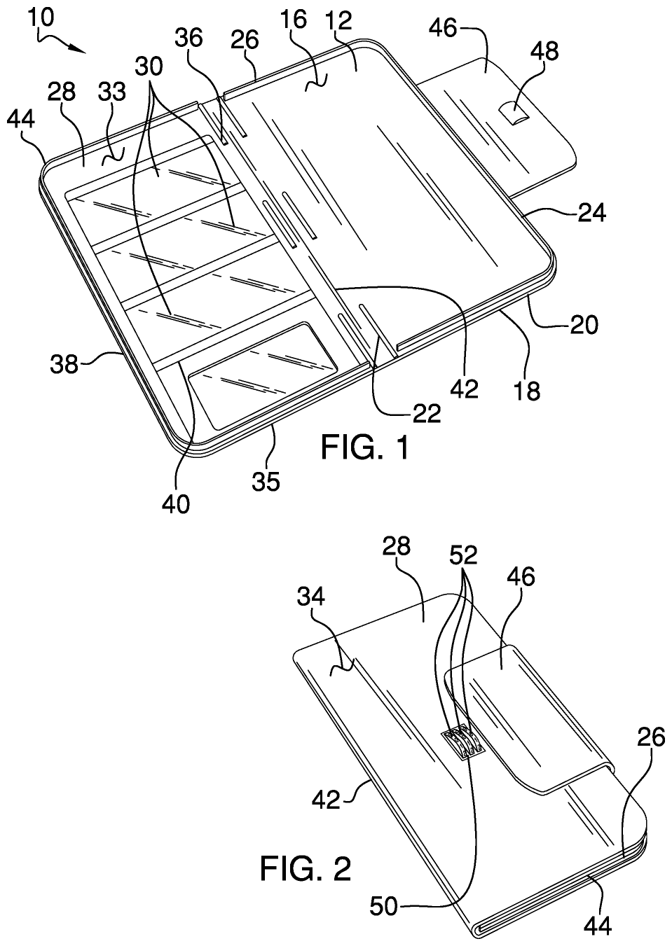

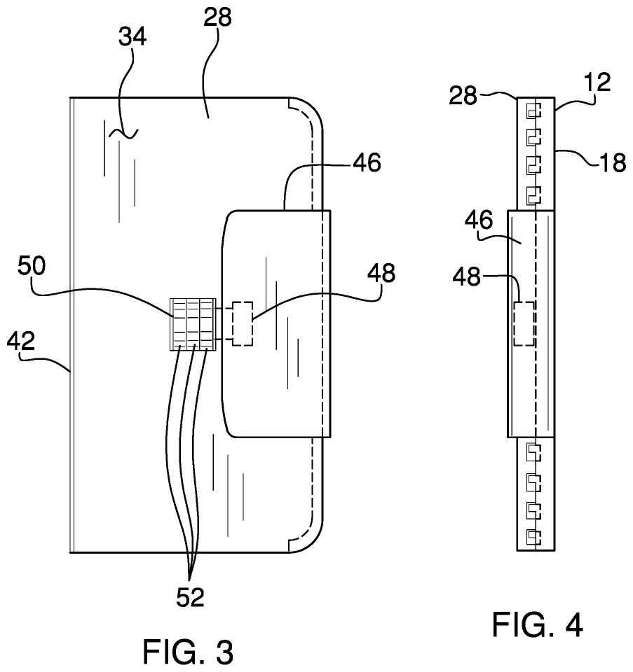

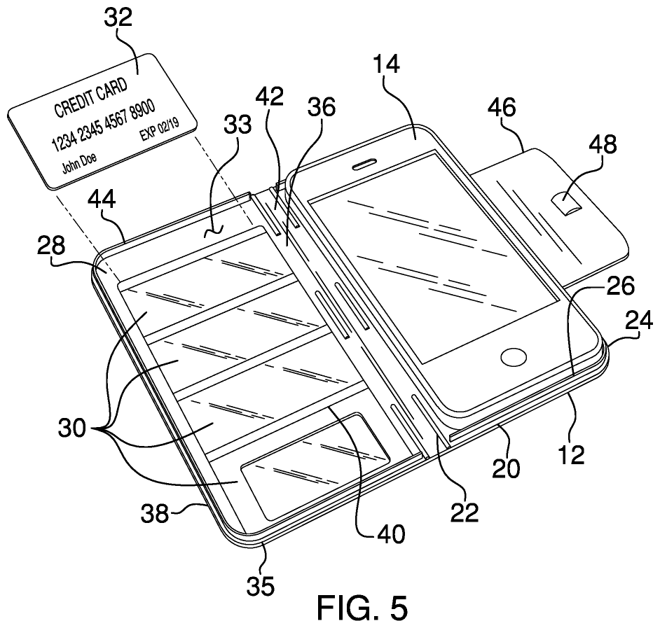

With reference now to the drawings, and in particular to FIGS. 1 through 6 thereof, a new carrying case device embodying the principles and concepts of an embodiment of the disclosure and generally designated by the reference numeral 10 will be described.

As best illustrated in FIGS. 1 through 6, the cellphone and credit card case assembly 10 generally comprises a first panel 12 and a cellphone 14 that positionable thereon. The first panel 12 has a first surface 16, a second surface 18 and a peripheral edge 20 extending therebetween. The peripheral edge 20 has a front side 22 and a back side 24, and the cellphone 14 is positionable on the first surface 16. A first lip 26 is coupled to and extends away from the first surface 16 and the first lip 26 is aligned with the peripheral edge 20. The first lip 26 is coextensive with the peripheral edge 20 with exception to the front side 22 and the first lip 26 restrains the cellphone 14 on the first surface 16.

A second panel 28 is hingedly coupled to the first panel 12 and each of the first 12 and second 28 panels is positionable in a closed position such that the first 12 and second 28 panels forms a case. The second panel 28 has a plurality of pockets 30 thereon that each insertably receives a respective one of a plurality of cards 32 for storing the cellphone 14 and the cards 32. The cards 32 may include credit cards, debit cards, a driver's license and other cards that contain user sensitive information. The cellphone 14 and each of the cards 32 is contained within the case when the first 12 and second 28 panels are closed.

The second panel 28 has a primary surface 33, a secondary surface 34 and an outer edge 35 extending therebetween. The outer edge 35 has a forward side 36 and a rearward side 38, and each of the pockets 30 is positioned on the primary surface 33. Each of the pockets 30 has a receiving end 40 and the receiving end 40 of each of the pockets 30 is open for insertably receiving the respective card 32. A hinge 42 is coupled between each of the first 12 and second panel 28s. The hinge 42 extends between the front side 22 of the peripheral edge 20 of the first panel 12 and the forward side 36 of the outer edge 35 of the second panel 28. The hinge 42 may be comprised of a deformable material, the hinge 42 may be a mechanical hinge or any other type of hinge 42.

A second lip 44 is coupled to and extends away from the primary surface 33 and the second lip 44 is aligned with the outer edge 35. The second lip 44 is coextensive with the outer edge 35 with exception to the forward side 36. Additionally, the second lip 44 engages the first lip 26 when the first 12 and second 28 panels are positioned in the closed position thereby inhibiting the cards 32 from being visible. A closure flap 46 is coupled to the first panel 12 and the closure flap 46 is positioned on the back side 24 of the peripheral edge 20. The closure flap 46 lies on the secondary surface 34 of the second panel 28 when the first 12 and second 28 panels are positioned in the closed position.

An engagement 48 is coupled to the closure flap 46 and a lock 50 is movably coupled to the second panel 28. The lock 50 releasably engages the engagement 48 when the first 12 and second 28 panels are positioned in the closed position and the closure flap 46 is positioned to lie on the second panel 28. In this way the lock 50 inhibits the cards 32 and the cellphone 14 from being removed from the case when the lock 50 engages the engagement 48. Moreover, the lock 50 is manipulated to enter an unlock code into the lock 50 for releasing the engagement 48. In this way the first 12 and second 28 panels can be positioned in an open position for accessing the cards 32 and the cellphone 14.

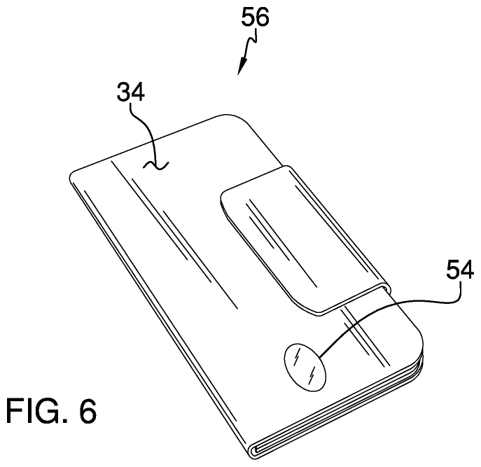

The lock 50 may comprise a plurality of tumblers 52 that is each rotatably coupled to the second panel 28. Each of the tumblers 52 is positioned in a pre-determined arrangement for unlocking the lock 50. In an alternative embodiment 54 as shown in FIG. 6, the lock 50 may comprise a biometric sensor 56 that is coupled to the second panel 28. The biometric sensor 56 is touched by a user to detecting biometrics of the user. Additionally, the lock 50 releases the engagement 48 when the biometric sensor 56 senses biometrics of the user that match a predetermined biometric. The biometric sensor 56 may be an electronic finger print reader or the like.

In use, the cellphone 14 is positioned on the first panel 12 and each of the cards 32 is inserted into a respective one of the pockets 30. The first 12 and second 28 panels are positioned in the closed position and the closure flap 46 is folded over onto the second panel 28. Thus, the lock 50 engages the engagement 48 to retain the first 12 and second 28 panels in the closed position. In this way the cellphone 14 and the cards 32 can be securely stored or transported. Additionally, the first 26 and second 44 lips inhibit the cards 32 and the cellphone 14 from being visible when the first 12 and second 28 panels are closed thereby enhancing security of information on the cards 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A cellphone and credit card case assembly comprising:
a first panel having a cellphone being positionable thereon, said first panel having a first surface, a second surface and a peripheral edge extending therebetween, said peripheral edge having a front side and a back side, said cellphone being positionable on said first surface;
a second panel being hingedly coupled to said first panel, each of said first and second panels being positionable in a closed position such that said first and second panels forms a case, said second panel having a plurality of pockets thereon each insertably receiving a respective one of a plurality of cards for storing said cellphone and said cards, said cellphone and each of said cards being contained within said case when said first and second panels are closed, said second panel having a primary surface, a secondary surface and an outer edge extending therebetween, said outer edge having a forward side and a rearward side, each of said pockets being positioned on said primary surface, each of said pockets having a receiving end, said receiving end of each of said pockets being open for insertably receiving the respective card;
a hinge being coupled between each of said first and second panels, said hinge extending between said front side of said peripheral edge of said first panel and said forward side of said outer edge of said second panel;
a closure flap being coupled to said first panel;
an engagement being coupled to said closure flap;
a lock being coupled to said second panel, said lock releasably engaging said engagement when said first and second panels are positioned in said closed position and said closure flap is positioned to lie on said second panel;
a first lip being coupled to and extending away from said first surface of said first panel, said first lip being aligned with said peripheral edge of said first panel, said first lip being coextensive with said peripheral edge with exception to said front side, said first lip restraining said cellphone on said first surface, said first lip having a length extending away from said first surface of said panel less than a thickness of said cellphone; and
a second lip being coupled to and extending away from said primary surface of said second panel, said second lip being aligned with said outer edge of said second panel, said second lip being coextensive with said outer edge with exception to said forward side, said second lip engaging said first lip when said first and second panels are positioned in said closed position thereby inhibiting the cards from being visible.

2. (canceled)

3. (canceled)

4. The assembly according to claim 1, wherein said lock inhibits the cards and the cellphone from being removed from said case when said lock engages said engagement, said lock being manipulated to enter an unlock code into said lock for releasing said engagement thereby facilitating said first and second panels to be positioned in an open position for accessing the cards and the cellphone.

5. The assembly according to claim 4, wherein said lock comprises a plurality of tumblers each being rotatably coupled to said second panel, each of said tumblers being positioned in a pre-determined arrangement for unlocking said lock.

6. The assembly according to claim 4, wherein said lock comprises a biometric sensor being coupled to said second panel wherein said biometric sensor is configured to be touched by a user to detecting biometrics of the user, said lock releasing said engagement when said biometric sensor senses biometrics of the user that match a predetermined biometric.

7. A cellphone and credit card case assembly comprising:
a first panel having a cellphone being positionable thereon, said first panel having a first surface, a second surface and a peripheral edge extending therebetween, said peripheral edge having a front side and a back side, said cellphone being positionable on said first surface;
a first lip being coupled to and extending away from said first surface, said first lip being aligned with said peripheral edge, said first lip being coextensive with said peripheral edge with exception to said front side, said first lip restraining said cellphone on said first surface, said first lip having a length extending away from said first surface of said panel less than a thickness of said cellphone;
a second panel being hingedly coupled to said first panel, each of said first and second panels being positionable in a closed position such that said first and second panels forms a case, said second panel having a plurality of pockets thereon each insertably receiving a respective one of a plurality of cards for storing said cellphone and said cards, said cellphone and each of said cards being contained within said case when said first and second panels are closed, said second panel having a primary surface, a secondary surface and an outer edge extending therebetween, said outer edge having a forward side and a rearward side, each of said pockets being positioned on said primary surface, each of said pockets having a receiving end, said receiving end of each of said pockets being open for insertably receiving the respective card;
a hinge being coupled between each of said first and second panels; said hinge extending between said front side of said peripheral edge of said first panel and said forward side of said outer edge of said second panel;
a second lip being coupled to and extending away from said primary surface, said second lip being aligned with said outer edge, said second lip being coextensive with said outer edge with exception to said forward side, said second lip engaging said first lip when said first and second panels are positioned in said closed position thereby inhibiting the cards from being visible;
a closure flap being coupled to said first panel, said closure flap being positioned on said back side of said peripheral edge, said closure flap lying on said secondary surface of said second panel when said first and second panels are positioned in said closed position;
an engagement being coupled to said closure flap; and
a lock being movably coupled to said second panel, said lock releasably engaging said engagement when said first and second panels are positioned in said closed position and said closure flap is positioned to lie on said second panel, said lock inhibiting the cards and the cellphone from being removed from said case when said lock engages said engagement, said lock being manipulated to enter an unlock code into said lock for releasing said engagement thereby facilitating said first and second panels to be positioned in an open position for accessing the cards and the cellphone.

8. The assembly according to claim 7, wherein said lock comprises a plurality of tumblers each being rotatably coupled to said second panel, each of said tumblers being positioned in a pre-determined arrangement for unlocking said lock.

9. The assembly according to claim 7, wherein said lock comprises a biometric sensor being coupled to said second panel wherein said biometric sensor is configured to be touched by a user to detecting biometrics of the user, said lock releasing said engagement when said biometric sensor senses biometrics of the user that match a predetermined biometric.
